(19) United States
(12) Patent Application Publication
(10) Pub. No.: US 2003/0029950 A1
(43) Pub. Date: Feb. 13, 2003

(54) Position control strategy for reel-to-reel tape drives with two tachometers

(75) Inventors: Shiba P. Panda, Englewood, CO (US); Robert O. Wyman, Longmont, CO (US); Andrew P. Engelmann, Boulder, CO (US); Linus Tsung-Shu Wang, Boulder, CO (US)

Correspondence Address: Wayne P. Bailey, Storage Technology Corporation, One Storage Tek Drive, Louisville, CO, 80028-4309, US

(73) Assignee: Storage Technology Corporation

(21) Appl. No.: 09/917,354

(22) Filed: Jul. 30, 2001

(51) Int. Cl. G11B 15/54

(52) U.S. Cl. 242/334.3; 242/334.5

(57) ABSTRACT

The present invention provides two methods, apparatus, and computer instructions for controlling tape movement in a tape drive system. In the first method, the direction of tape movement is determined with respect to a file reel and a machine reel. If the direction of tape movement is toward the file reel, the tape is moved using machine reel control, and if the direction of tape movement is toward the machine reel, the tape is moved using file reel control. In the second method, the size of a file reel, designated as the file radius, and the size of a machine reel, designated as the machine radius, are determined. If the machine radius is smaller than the file radius, tape motion is carried out using machine reel control, and if the file radius is equal to or smaller than the machine radius, tape motion is carried out using file reel control.

### BACKGROUND OF THE INVENTION

1. Field of the Invention

The present invention relates generally to a tape drive system for reading data from and writing data to and from storage media. In particular, the present invention relates to a method and apparatus for controlling the position of tape in reel-to-reel tape drives.

2. Background of the Invention

Magnetic tape is a widely used data storage media. Tape drives and their corresponding tape media are applied to data storage tasks in all levels of computer data storage from personal computers to workstations to mainframes and supercomputers. Tape products are available in many formats from many vendors in a wide range of cost categories ranging from less than one hundred to many ten's of thousands of dollars.

Automated tape media handling systems complement tape drives and have become commonplace in the data storage industry by offering the increased performance of tape cartridge loading and unloading robotically in and out of tape drives. Automation has turned magnetic tape from an “off-line” storage device requiring human intervention (typically taking minutes) to load and unload tape to a more “near online” system termed “nearline” (typically taking seconds). Nearline tape systems combine the desirable low cost of tape storage with access times longer than traditional “online” disk or solid state based data storage systems but fast enough to meet many online performance requirements with lower storage cost. With the nearline class of storage and the speed of robotics, the tape drive's access time, the time to load a tape cartridge then locate and access its data, has become a significant performance parameter.

To respond to the demands of the competitive marketplace it is vital to develop and offer products that have the highest performance at the lowest cost. Design trade-offs are made to balance cost against performance.

To increase access time performance at a lower cost, reel sizes (radii) must be reduced and initial load of the tape must be done at the midpoint of tape (equal tape length on each reel) such that data can quickly be accessed in either direction. Reduced reel sizes allow for smaller reel motors, amplifiers, and power supply to be used. Additionally, smaller cooling fans and simpler non-pneumatic tape paths are used. All of this “miniaturization” aids in increasing access time and in lowering cost. Further cost reduction and simplification measures include cheaper and more flexible reel motor couplings and fewer feedback sensors (i.e., no tape tension transducer).

These simpler reel-to-reel tape drives with flexible motor coupling and no tension transducer may fail while in tachometer position control and while reading/writing short records or moving a small distance. The symptom for these failures is typically loss of tension and it occurs while pulling the tape from a small radius reel of tape onto a large radius reel. In these drives and earlier drives, the reel position is always controlled with respect to a common reference reel irrespective of the direction of motion. This common reference reel is arbitrarily designated as the file reel and the other reel as the machine reel.

Position control in these reel-to-reel tape drives is inherently difficult due to the lack of tension transducer to cut down tension oscillations during position maneuvers. There is a tendency of the tape to stick to various tape path surfaces in a stopped condition due to lack of air in the tape path. When the tape is stuck to a tape path surface, the required current to move the tape along the surface during attempted acceleration is increased. Static friction currents are difficult to predict. A mismatch, between an applied current to overcome the friction and very low speed conditions, contributes to the position loop instability.

Therefore, it would be desirable to have a method and apparatus to increase the performance of reel-to-reel tape drives with an improved position control strategy.

### SUMMARY OF THE INVENTION

The present invention provides a removable media system, such as a tape drive system, with improved performance. In a preferred embodiment, a method and apparatus is disclosed to provide an enhanced and unique position control strategy, which improves performance through the reduction of position tracking errors in a tape drive system.

The present invention provides a method, apparatus, and computer instructions for controlling tape movement in a tape drive system. The direction of tape movement is determined with respect to a file reel and a machine reel. If the direction of tape movement is toward the file reel, the tape is moved using machine reel control and if the direction of tape movement is toward the machine reel, the tape is moved using file reel control (see FIG. 2).

The present invention also provides an alternative method, apparatus, and computer instructions for controlling tape movement in a tape drive system using a file radius and a machine radius to control the tape movement. In this method, the size of a file reel, designated as the file radius, and the size of a machine reel, designated as the machine radius, are determined. If the machine radius is smaller than the file radius, tape motion is carried out using machine reel control and if the file radius is equal to or smaller than the machine radius, tape motion is carried out using file reel control.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of the components of a reel-to-reel tape drive system in accordance with a preferred embodiment of the present invention;

FIG. 2 is a block diagram of the original operation mode using file reel position control for a reel-to-reel tape drive in accordance with a preferred embodiment of the present invention;

FIG. 3 is a block diagram of the original operation mode using file reel position control for a reel-to-reel tape drive in the beginning of tape position in accordance with a preferred embodiment of the present invention;

FIG. 4 is a block diagram of the operation mode with the new position control strategy for a reel-to-reel tape drive according to the present invention;

FIG. 5 is a flowchart of the position control strategy according to the present invention;

FIG. 6 is a block diagram which demonstrates the center-of-tape condition for a reel-to-reel tape drive in accordance with a preferred embodiment of the present invention;

FIG. 7 is a block diagram of the operation mode with another position control strategy for a reel-to-reel tape drive according to the present invention;

FIG. 8 is a flowchart of another position control strategy according to the present invention; and

FIG. 9 is a graph of position tracking error for the file reel control mode and the switched control mode with respect to time according to the present invention.

### DETAILED DESCRIPTION OF THE PREFERRED EMBODIMENT

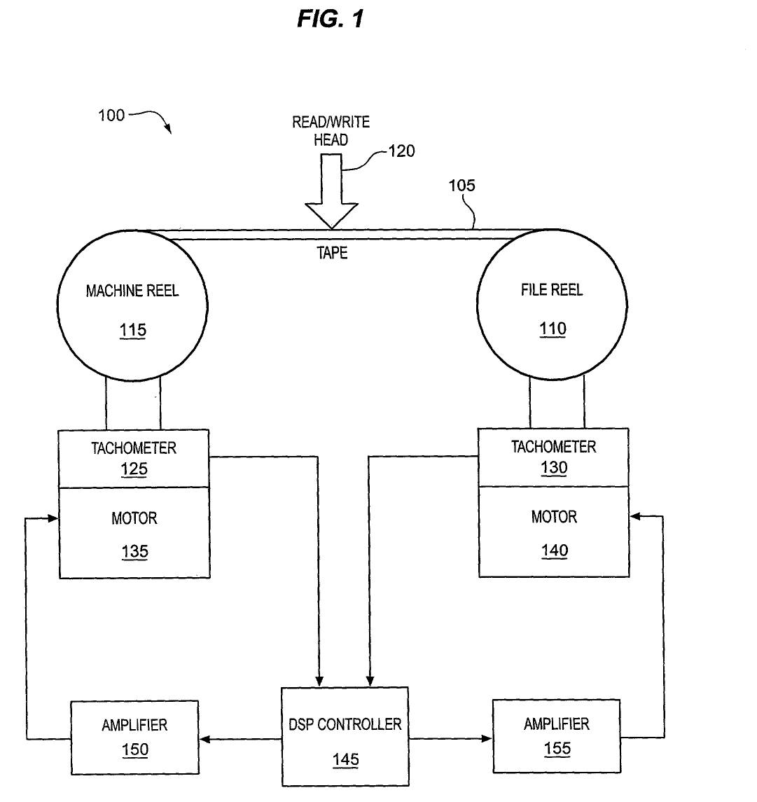

With reference now to the figures and in particular to FIG. 1, a block diagram of the components of a reel-to-reel tape drive system is depicted in accordance with a preferred embodiment of the present invention. Reel-to reel tape drive system 100 is an example of a tape system in which the present invention may be implemented. The tape drive system contains magnetic tape 105, which is connected from file reel 110 to machine reel 115. Read/write head 120 stores and retrieves data from the tape. Tachometer 125, tachometer 130, motor 135, and motor 140 are attached to file reel 110 and machine reel 115, respectively, by motor shafts (not shown). Tachometers 125 and 130 send data signals to digital signal processor (DSP) controller 145, which routes the signals through amplifiers 150 and 155.

In the depicted examples, tachometers 125 and 130 are implemented using encoders. An encoder senses and indicates rotation of the motor shaft. One such position encoder uses Hall-effect devices to sense the movement of magnetized areas on the motor shaft. The Hall-effect device provides a phase and quadrature signal indicating speed and displacement of the motor shaft. These signals have an AC component that varies about a DC offset level. The AC component varies as a function of position. For example, the AC component may be a sinusoid, where each period of the sine wave indicates a certain amount of shaft displacement. To position file reel 110 or machine reel 115, DSP controller 145 determines the actual position based on position encoder signals received from the encoders and moves the motor to position the reel to the desired position. The amplifiers change the level of the signal generated by DPS controller 145 for use by motors 135 and 140.

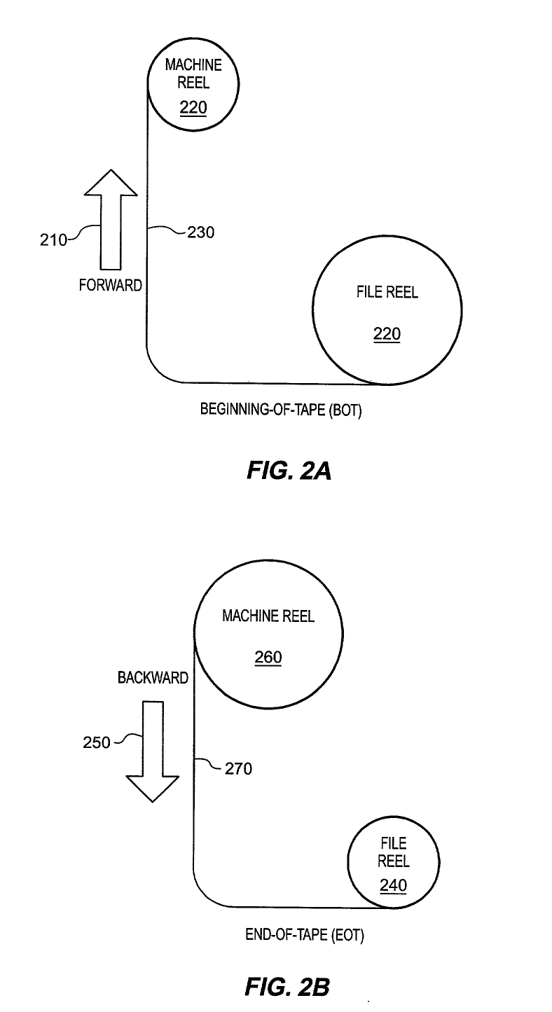

Turning next to FIG. 2A and FIGS. 2B, block diagrams of the operation mode with file reel position control for a reel-to-reel tape drive as currently used are depicted in accordance with a preferred embodiment of the present invention.

In FIG. 2A, the beginning of tape (BOT) condition occurs when most of the tape is located on file reel 200. A forward motion, as indicated by arrow 210, is performed with file reel control. The encoder associated with motor for file reel 200 causes tape 230 to be pushed on machine reel 220 with file reel position control. The end of tape (EOT) condition occurs when almost all of the tape is on machine reel 260. In FIG. 2B, a backward motion, as indicated by arrow 250, of tape 270 causes tape 270 to be pulled onto file reel 240 with file reel position control.

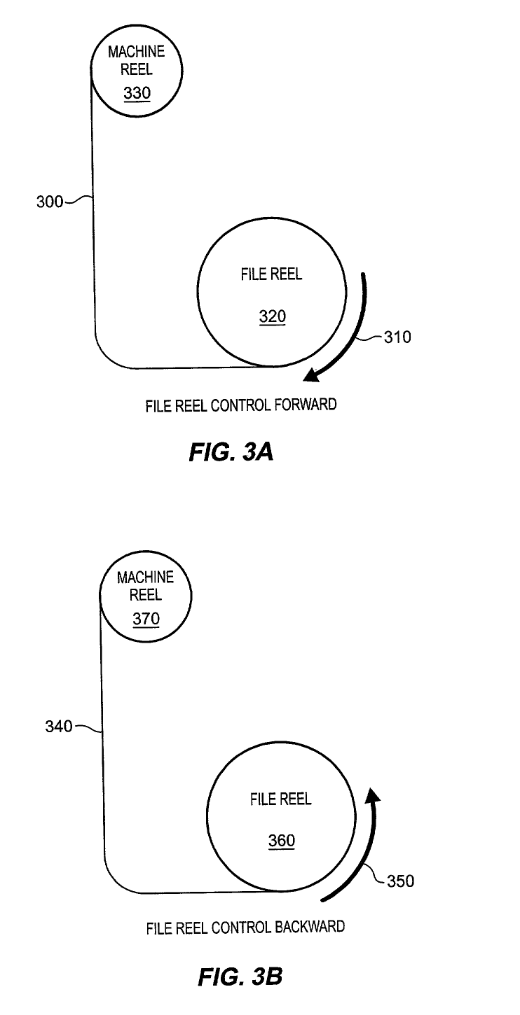

Continuing to FIGS. 3A and 3B, a block diagram of the current operation mode using file reel position control for a reel-to-reel tape drive in the beginning of tape position is depicted in accordance with a preferred embodiment of the present invention.

In FIG. 3A, tape 300 is pushed in a forward motion, as shown by arrow 310, from file reel 320 to machine reel 330 in the BOT condition. In FIG. 3B, tape 340 is pulled in a backward motion, as illustrated by arrow 350, to file reel 360 from machine reel 370 in the BOT condition. Failures have been observed when the tape is in file reel position control while moving in the backward toward BOT direction near the BOT. Pulling tape onto a large radius reel, such as BOT, while the file reel position is controlled, contributes to instability.

The present invention provides a method and apparatus to use file reel position control while moving in the forward direction and switching to machine reel position control while the tape motion is in the backward direction. Loss of tension occurs more frequently when accelerating from zero velocity while pulling tape onto a large radius reel. The position control strategy is improved by using the machine reel to perform the backward motion by pushing the tape onto the file reel rather than having the file reel pull the tape. The present invention recognizes that slow and small movements may cause static friction. A greater current is needed to move tape when static friction is present.

The mechanism of the present invention changes the reel that controls the tape movement. The reel controlling the tape movement also is referred to as the control reel. This reel is the one from which position information is gathered via the encoder and used to move the tape. For example, if the file reel is used for control, the control is referred to as file reel control. If the machine reel is used for control, this type of control is referred to as machine reel control. The change is such that the control reel always pushes tape. The mechanism avoids having the control reel pull tape and reduces the possibility of tape breakage or loss of tension. The changing of the control reel also is referred to as a switched-mode control.

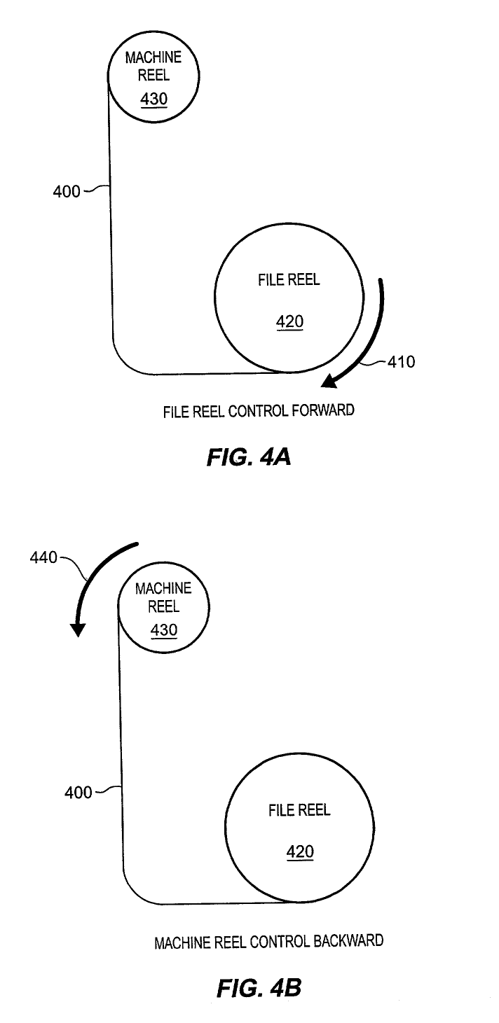

Turning next to FIGS. 4A and 4B, block diagrams of the operation mode with a switched-mode control strategy for a reel-to-reel tape drive as described in accordance with a preferred embodiment of the present invention. The positioning system of the present invention illustrated in these figures may be implemented within reel-to reel tape drive system 100 in FIG. 1.

In FIG. 4A, tape 400 is pushed in a forward motion as indicated by arrow 410, from file reel 420 to machine reel 430 in the BOT position. In this direction, the encoder and motor associated with file reel 420 are used to control the positioning of tape 400.

When the direction of the tape changes, the mechanism of the present invention uses the machine reel control for the backward motion, as indicated by arrow 440 in FIG. 4B. In other words, the control of this motion is provided through the encoder and motor associated with machine reel 430, rather than the encoder and motor associated with file reel 420. In particular, the position control signals are sent to the motor for machine reel 430. Thus, tape 400 is pushed in backward motion 440 from machine reel 430 to file reel 420 in the BOT position. Pushing tape onto a large radius reel, such as BOT, is a stable operation as compared to pulling tape onto such a large radius reel.

As illustrated in FIGS. 4A and 4B, the reel controlled in moving tape is such that the tape is always being pushed relative to the control reel.

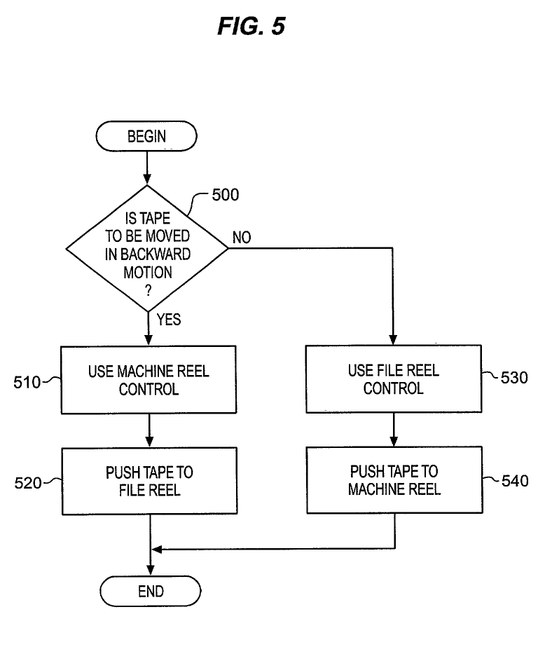

With reference now to FIG. 5, a flowchart of switched-mode control strategy is depicted in accordance with a preferred embodiment of the present invention. The process illustrated in FIG. 5 may be implemented in a controller such as digital signal processor controller 145 in FIG. 1.

The process begins with a determination as to whether the tape is to be moved backward or forward (step 500). Backward movement occurs if the machine reel is to push the tape. If the tape is to be moved in a backward motion, then machine reel control is selected (step 510). Tape movement is then controlled by using the machine reel to push the tape from the machine reel to the file reel (step 520) with the process terminating thereafter.

Turning back to step 500, if the tape is to be moved in a forward motion, then file reel control is selected for use in tape movement (step 530). Then, file reel control is used to push the tape from the file reel to the machine reel (step 540) with the process terminating thereafter. As can be seen, the reel used to control tape movement is changed such that the reel selected for use in controlling tape movement always causes the tape to be pushed from the control reel to the other reel.

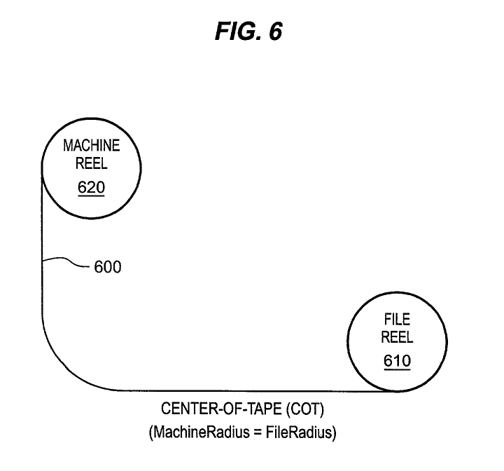

Turning next to FIG. 6, a block diagram which demonstrates the center-of-tape condition for a reel-to-reel tape drive is depicted in accordance with a preferred embodiment of the present invention. Another way to implement the switched-mode control and to avoid pulling tape onto a reel of large radius when that reel is the control reel is switching the control reel at the center-of-tape (COT). FIG. 6 shows the center-of-tape (COT) condition when half of tape 600 is located on file reel 610 and the other half of tape is located on machine reel 620. The file reel radius (FileRadius) and the machine reel radius (MachineRadius) are equal at this point.

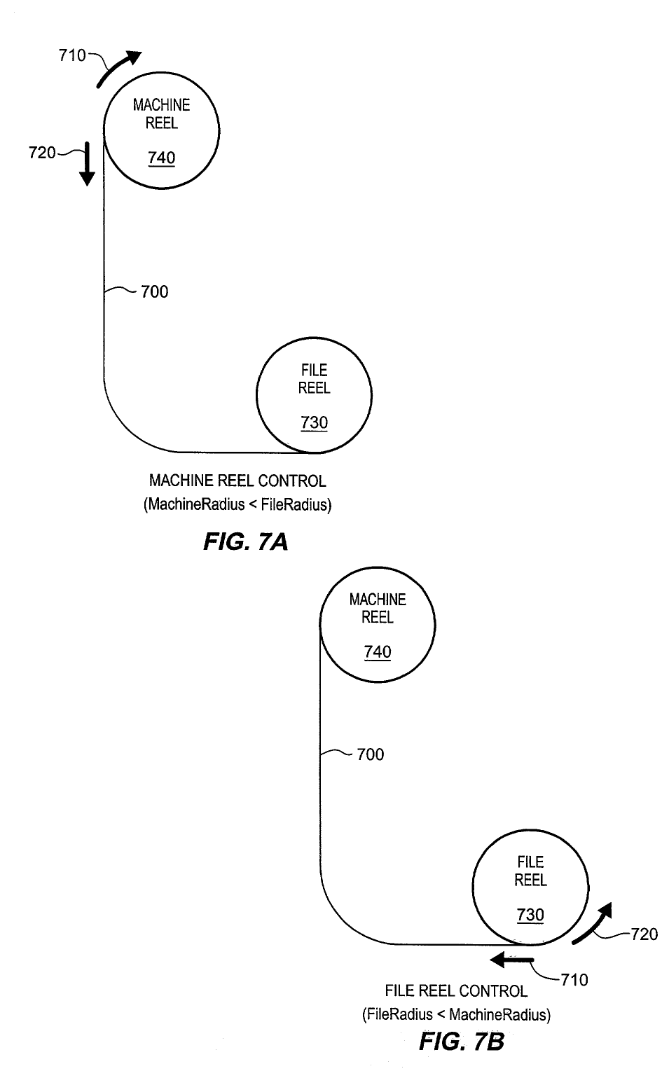

With reference now to FIGS. 7A and 7B, block diagrams of an operation mode with another switched-mode control strategy for a reel-to-reel tape drive are depicted in accordance with a preferred embodiment of the present invention. In this example, the switching depends on the relative reel radii or the relative size of the reels. The positioning of the present invention illustrated in these figures may be implemented within reel-to-reel tape drive system 100 in FIG. 1.

In FIG. 7A, tape 700 is pushed in a forward motion as indicated by arrow 710, from file reel 730 to machine reel 740 in the position where the MachineRadius is less than the FileRadius. In this situation, the encoder and motor associated with machine reel 740 are used to control the positioning of tape 700, i.e. machine reel control is used.

As the tape motion continues in the forward direction, as shown by arrow 710 and when the FileRadius becomes smaller than the MachineRadius just as the COT position is crossed, the mechanism of the present invention switches to the file reel control for the continued forward motion, as indicated by arrow 710 in FIG. 7B. In other words, control of the motion is provided through the encoder and motor associated with file reel 730. The file reel control in forward direction, as depicted by arrow 710 in FIG. 7A, continues until the machine becomes full, i.e. EOT condition is reached. As the direction of motion of tape changes from forward direction of arrow 710 to backward direction of arrow 720 as shown in FIG. 7B, file reel control is still continued for backward direction, as depicted by arrow 720.

As the tape motion continues in the backward direction of arrow 720 in FIG. 7B, and as soon as the MachineRadius becomes smaller than the FileRadius, the position control is switched to machine reel control, as indicated by arrow 720 in FIG. 7A.

The present invention recognizes that the machine reel control of tape motion in the backward direction of arrow 720 and forward direction 710 in FIG. 7A takes place as long as the MachineRadius is smaller than the FileRadius. Similarly, file reel control of the tape motion in the forward direction of arrow 710 and backward direction of arrow 720 in FIG. 7B is carried out as long as the FileRadius is smaller than or equal to the MachineRadius.

In this switched-mode control, any pulling of tape onto a control reel or pushing of tape out of a control reel takes place when that reel has a size less than or equal to one half of the maximum reel size. In this way, pulling of tape onto a control reel of large radius and associated stability problem is completely avoided.

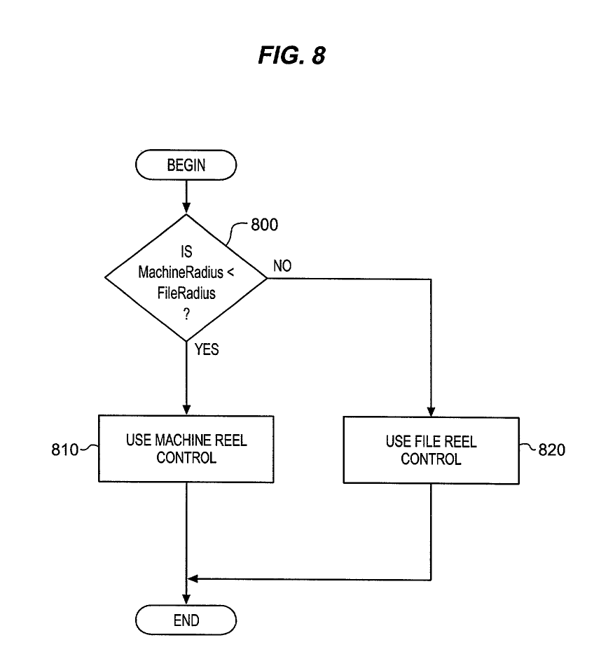

Turning next to FIG. 8, a flowchart of another switched-mode control strategy where the switching of control reel depends on the reel size is depicted in accordance with a preferred embodiment of the present invention. The process illustrated in FIG. 8 may be implemented in a controller such as digital signal processor controller 145 in FIG. 1.

The process begins with a determination as to whether the MachineRadius is smaller or equal to the FileRadius (step 800). If the MachineRadius is smaller than the FileRadius, then machine reel control is used irrespective of direction of tape motion (step 810) with the process terminating thereafter. Otherwise, file reel control is used independent of the direction of tape motion (step 820) with the process terminating thereafter.

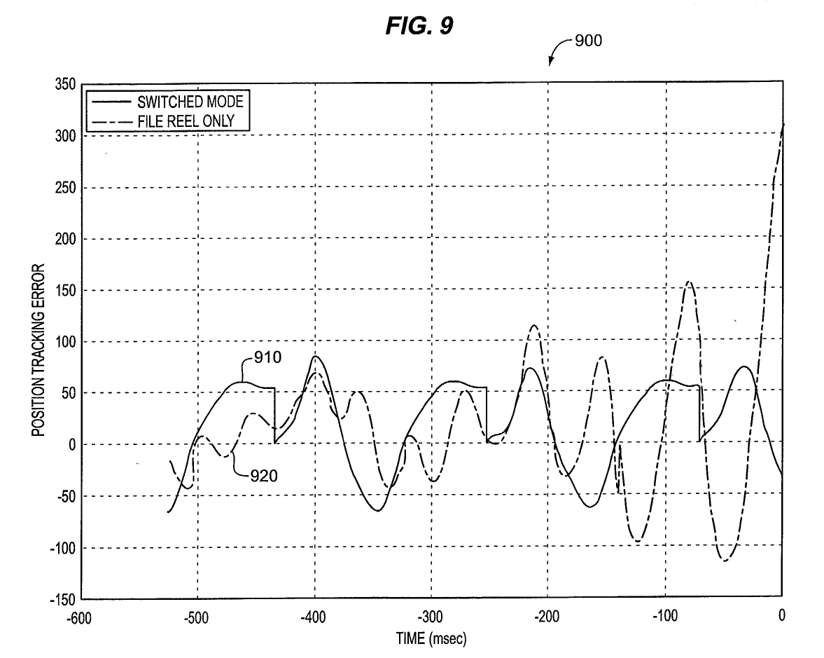

With reference now to FIG. 9, a graph of position tracking error for the file reel control mode and the switched control mode as described in the present invention with respect to time with either method of implementation. Graph 900 shows test results of position tracking error for the switched control strategy. The data displayed in line 910 represents the switched control strategy compared to the file reel control. With respect to time, file reel control data is represented by line 920. Data from this test validates the present invention using switched control mode as generating less position tracking error.

The present invention is important in controlling tape movement because of the critical need to be able to perform rapid starts and stops on tape drive systems to ensure high performance during position control. The present invention enables rapid starts, stops, repositioning, and achievement of full functionality for tape drives.

It is important to note that while the present invention has been described in the context of a fully functioning tape drive system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as a floppy disk, a hard disk drive, a RAM, CD-ROMs, and transmission-type media, such as digital and analog communications links.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a tape drive system for controlling tape movement, the method comprising the tape drive system implemented steps of:
determining a direction of tape movement of a tape with respect to a file reel and a machine reel;
if the direction of tape movement is toward the file reel, moving the tape using machine reel control; and
if the direction of tape movement is toward the machine reel, moving the tape using file reel control.

2. The method of claim 1, wherein the determining step comprises:
receiving data from a first tachometer associated with the file reel and receiving data from a second tachometer associated with the machine reel.

3. The method of claim 1, wherein the machine reel control causes the tape movement to push the tape towards file reel.

4. The method of claim 1, wherein the file reel control causes the tape movement to push the tape towards machine reel.

5. A tape drive apparatus comprising:
a tape head, wherein the tape head accesses data on a magnetic tape placed within the tape apparatus, wherein the magnetic tape is moveable between a first reel and a second reel;
a first motor, wherein the first motor rotates the first reel;
a first tachometer, wherein the first tachometer generates first data with respect to rotation of the first reel;
a second motor, wherein the second motor rotates the second reel;
a second tachometer, wherein the second tachometer generates second data with respect to rotation of the second reel; and
a controller, wherein the controller is connected to the first tachometer, the second tachometer, the first motor, and the second motor, and wherein the controller controls movement of the magnetic tape by using the first data if the tape is being moved in a direction from the first reel to the second reel and using the second data if the tape is being moved in a direction from the second reel to the first reel.

6. The tape drive apparatus of claim 5, wherein the controller is a processor.

7. The tape drive apparatus of claim 5, wherein the controller is a digital signal processor.

8. The tape drive apparatus of claim 5, wherein first reel is a file reel and the second reel is machine reel.

9. The tape drive apparatus of claim 5, wherein the first tachometer is a first encoder and the second tachometer is a second encoder.

10. The tape drive apparatus of claim 5, wherein the first motor is connected to the controller through a first amplifier and the second motor is connected to the controller by a second amplifier.

11. The tape drive apparatus of claim 5, wherein the tape head is a read/write head.

12. The tape drive apparatus of claim 5, wherein the controller controls position of the tape by sending signals to the first motor when the first data is used.

13. The tape drive apparatus of claim 5, wherein the controller controls position of the tape by sending signals to the second motor when the second data is used.

14. A tape drive system for controlling tape movement, the tape drive system comprising:
determining means for determining a direction of tape movement of a tape with respect to a file reel and a machine reel;
first moving means for moving the tape using machine reel control if the direction of tape movement is toward the file reel; and
second moving means for moving the tape using file reel control if the direction of tape movement is toward the machine reel.

15. The tape drive system of method of claim 14, wherein the determining means comprises:
receiving means for receiving data from a first tachometer associated with the file reel and receiving data from a second tachometer associated with the machine reel.

16. The tape drive of claim 15, wherein pulling of tape onto the machine control reel from the file control reel takes place when the tape on the machine control reel has a radius less than one half a maximum reel radius for the machine control reel.

17. The tape drive of claim 15, wherein pushing of tape out of the machine control reel to the file control reel takes place when the tape on the machine control reel has a radius less than one half a maximum reel radius for the machine control reel.

18. The tape drive of claim 15, wherein pulling of tape onto the file control reel from the machine control reel takes place when the tape on the file control reel has a radius less than or equal to one half a maximum reel radius for the file control reel.

19. The tape drive of claim 15, wherein pushing of tape out of the file control reel to the machine control reel takes place when the tape on the file control reel has a radius less than or equal to one half a maximum reel radius for the file control reel.

20. The tape drive system of claim 14, wherein the machine reel control causes the tape movement to push the tape towards file reel.

21. The tape drive system of claim 14, wherein the file reel control causes the tape movement to push the tape towards machine reel.

22. A computer program product in a computer readable medium for controlling tape movement in a tape drive system, the computer program product comprising:
first instructions for determining a direction of tape movement of a tape with respect to a file reel and a machine reel;
second instructions for moving the tape using machine reel control if the direction of tape movement is toward the file reel; and
third instructions for moving the tape using file reel control if the direction of tape movement is toward the machine reel.

23. A tape drive system for controlling tape movement, the tape drive system comprising:
determining means for determining a radius of a file reel and a radius of a machine reel;
first moving means for moving the tape using machine reel control if the radius of the machine reel is less than the radius of the file reel; and
second moving means for moving the tape using file reel control if the radius of the file reel is less than or equal to the radius of the machine reel.

24. The tape drive of claim 23, wherein pulling of tape onto the machine control reel from the file control reel takes place when the tape on the machine control reel has a radius less than one half a maximum reel radius for the machine control reel.

25. The tape drive of claim 23, wherein pushing of tape out of the machine control reel to the file control reel takes place when the tape on the machine control reel has a radius less than one half a maximum reel radius for the machine control reel.

26. The tape drive of claim 23, wherein pulling of tape onto the file control reel from the machine control reel takes place when the tape on the file control reel has a radius less than or equal to one half a maximum reel radius for the file control reel.

27. The tape drive of claim 23, wherein pushing of tape out of the file control reel to the machine control reel takes place when the tape on the file control reel has a radius less than or equal to one half a maximum reel radius for the file control reel.

28. A computer program product in a computer readable medium for controlling tape movement in a tape drive system, the computer program product comprising:
first instructions for determining a radius of file reel and a radius of machine reel;
second instructions for moving the tape using machine reel control if the radius of the machine reel is less than the radius of the file reel; and
third instructions for moving the tape using file reel control if the radius of the file reel is less than or equal to the radius of the machine reel.
